(19) United States
(12) Patent Application Publication
(10) Pub. No.: US 2017/0116561 A1
(43) Pub. Date: Apr. 27, 2017

(54) CONNECTED HOTELS WORKER EXPERIENCE

(71) Applicant: Accenture Global Services Limited, Dublin (IE)

(72) Inventors: Jay Saddler, San Jose, CA (US); Erik Jacobson, St Albans (GB); Adam Johnston, Cambridge (GB); Anoop Gopinatha, Issaquah, WA (US)

(21) Appl. No.: 15/299,698

(22) Filed: Oct. 21, 2016

Related U.S. Application Data
(60) Provisional application No. 62/245,619, filed on Oct. 23, 2015.

(51) Int. Cl. G06Q 10/06; G06Q 50/12; G07C 9/00

(52) U.S. Cl. CPC G06Q 10/063116; G07C 9/00309; G07C 9/00904; G06Q 50/12

(57) ABSTRACT

Methods, systems, and apparatus for providing an enhanced hotel worker experience. Disclosed methods include the actions of receiving, from a device, a request to access a hotel room; processing the received request using a task management system; generating a corresponding output; and based on the generated output, sending instructions from the task management system granting access to the hotel room.

### CROSS-REFERENCE TO RELATED APPLICATIONS

This application claims the benefit of U.S. Provisional Pat. App. No. 62/245,619, filed Oct. 23, 2015, which is incorporated by reference.

### TECHNICAL FIELD

This document generally describes technology related to smart devices, such as sensors.

### BACKGROUND

Smart sensors, such as smart door locks, can automatically detect the presence of an authorized device and unlock doors using a wireless protocol and cryptographic key to execute the authorization process. For example, a smart door lock may connect to an authorized device, such as a smart phone or key fob, through a Bluetooth connection. In other examples a smart door lock may connect to a home internet connection via Wi-Fi.

### SUMMARY

This specification describes systems and methods for managing a workforce of employees in a hotel using a system of sensors located in and around the hotel. Innovative aspects of the subject matter described in this specification may be embodied in methods that include the actions of processing received data using a task management system; generating a corresponding output; and based on the generated output, sending instructions from the task management system to a hotel worker device to schedule a task.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination.

In some implementations, the device is a hotel worker device. In certain implementations, the device is a guest device. In certain aspects, processing the received request using a task management system comprises determining that the device is authorized to enter the room at the time that the request was received.

Further innovative aspects of the subject matter described in this specification may be embodied in methods that include the actions of receiving data from a device indicating the presence of a hotel guest in a hotel room; processing the received data using a task management system; and based on the processed data, sending instructions from the task management system to a hotel worker device to reschedule a task to a later time.

In some implementations, the device is an in-room sensor. In some further implementations, the in-room sensor is a motion sensor. In certain aspects, the method further comprises sending instructions from the task management system reassigning the task to a new hotel worker.

The subject matter described in this specification can be implemented in particular embodiments so as to realize one or more of the following advantages.

The management and scheduling of a large workforce such as that of a hotel is a complex and time consuming task. A connected hotel system, as described in this specification, may provide an efficient method of dynamically managing worker scheduling, schedule changes and task handling in order to reduce organizational overhead, improve task reliability and reduce the time spent on manual scheduling by a supervisor. Tracking the location of hotel guests, as described in this specification, enables the connected hotel system to provide updated information to the hotel worker devices in order to schedule services in a timely and unobtrusive manner.

The details of one or more embodiments of the subject matter described in this specification are set forth in the accompanying drawings and the description below. Other potential features, aspects, and advantages of the subject matter will become apparent from the description, the drawings, and the claims.

### DESCRIPTION OF DRAWINGS

FIG. 1 depicts a block diagram of an example connected hotel system.

FIGS. 2A and 2B depict diagrams of dynamically controlling hotel room access.

FIGS. 3A and 3B depict diagrams of a connected hotel worker process.

FIG. 4 depicts a flowchart of an example process for dynamically controlling hotel room access.

FIG. 5 depicts a flowchart of an example connected hotel worker process.

FIG. 6 is a block diagram of a computing system that can be used in connection with computer-implemented methods described in this document.

Like reference symbols in the various drawings indicate like elements.

### DETAILED DESCRIPTION

This specification describes a system for creating a digital, connected hotel worker system. Connected devices, including mobile devices, wearable devices, sensors, smart thermostats, lighting devices, smart keyless door locks and entertainment devices provide a digital hotel hub that enables a connected hotel system to achieve greater efficiency in the management of a hotel workforce for servicing the connected hotel property and client requests. On-property digital experiences may be consistent and functional due to dynamic task scheduling and real-time communication between hotel workers and hotel guests. A task management system uses real-time input from the connected devices to provide dynamic control of various aspects of worker management, e.g., shift preparation, problem reporting and solving, task rescheduling, and guest requests.

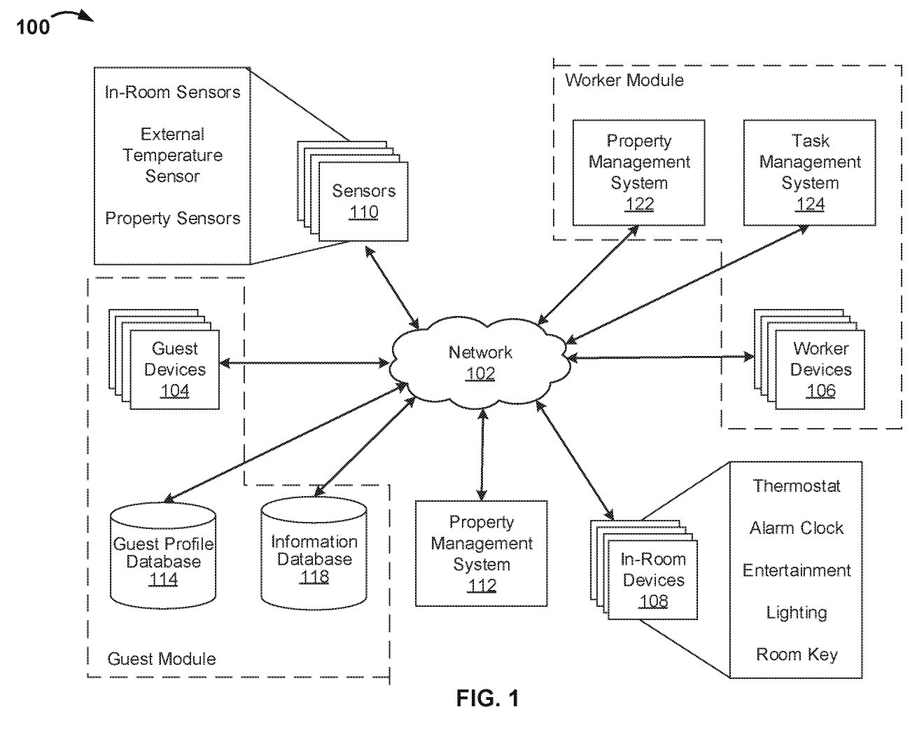

FIG. 1 depicts a block diagram of an example connected hotel system 100. The example connected hotel system 100 includes a network 102, e.g., a local area network (LAN), wide area network (WLAN), the Internet, or a combination thereof, guest devices 104, worker devices 106, in-room devices 108, sensors 110, property management system 112, guest profile database 114, information database 118, property management system 122 and task management system 124. The network 102 can be accessed over a wired and/or a wireless communications link. For example, mobile computing devices, such as smartphones can utilize a cellular network to access the network. It will be appreciated that the term “hotel” and the applicability of the invention extends beyond the preferred embodiment described. For example, the term “hotel” may include hotels, motels, inns, hostels, resorts, lodges, cruise ships and other commercial lodging facilities.

A guest device 104 is an electronic device that is under the control of a guest of the hotel and is capable of requesting and receiving information over the network 102. Example guest devices 104 include personal computers, mobile communication devices, e.g., smartphones and/or tablet computing devices, wearable devices and other devices that can send and receive data over the network 102. As used throughout this document the term mobile computing device (“mobile device”) refers to a guest device that is configured to communicate over a mobile communications network. A smartphone, (i.e., a phone that is enabled to communicate over the Internet) is an example of a mobile device. A guest device 104 typically includes a user application, e.g., a web browser, to facilitate the sending and receiving of data over the network 102.

A worker device 106 is an electronic device that is under the control of an employee (“worker”) of the hotel and is capable of requesting and receiving information over the network 102. Example worker devices 106 include personal computers, mobile communication devices, e.g., smartphones, smartwatches, and other wearable devices that can send and receive data over the network 102. As used throughout this document the term wearable computing device (“wearable device”) refers to a worker device that is configured to communicate over a mobile communications network. A smartwatch, (i.e., a watch that is enabled to communicate over the Internet) is an example of a wearable device. Other examples include mobile devices that are fitted with a clip mechanism and can be attached to items of clothing. A worker device 106 typically includes a user application, e.g., a web browser, to facilitate the sending and receiving of data over the network 102.

In some implementations, the worker devices 106 may be stored at a docking station and may be operable using employee accounts or other forms of identification. For example, an employee may be assigned an identity card, e.g., a near field communication (NFC) identity card that can store identity and authorization information relating to the employee. The identity card may be used to activate and personalize a worker device 106, e.g., by touching the worker device with the NFC identity card, enabling the worker device to download the current working schedule of the employee.

The worker devices 106 may include a microphone and allow for sound recordings to be made by a user of the worker device. For example, the worker device 106 may include a report function that enables a user of the worker device to create an audio report, e.g., reporting a broken item of furniture in a hotel room, that can be sent to the worker module for processing over the network 102.

An in-room device 108 is an electronic device that is located in a guest room of a hotel. Example in-room devices 108 include lighting devices, entertainment devices, smart thermostats, alarm clocks and smart (keyless) door locks. In-room devices are accessible from the guest devices 104 over the network 102. For example, lighting devices within a room of a hotel may be controlled using commands sent over the network 102 from an application installed on a guest mobile device. In another example, smart door locks for a room of a hotel may be controlled through communication between a guest mobile device and the smart door lock over the network 102, enabling keyless entry of the room. As used throughout this document, the term connected in-room device (“connected device”) refers to an in-room electronic device that is configured to communicate over a mobile communications network. The connected device may be an Internet-of-Things (IoT) connected device.

A sensor 110 is a device that detects events or changes in its environment and provides a corresponding output, e.g., using electronic signals. The sensors 110 are configured to communicate with other components of the connected hotel system, e.g., property management system 112, over the network 102.

One or more sensors 110 may be in-room sensors that are located in guest rooms. For example, in-room sensors may include movement sensors that are discretely positioned in a hotel room. Movement sensors may detect movement within the hotel room and provide as output an electronic signal indicating whether the room is occupied or not. The indication may be provided to the property management system 112 over the network 102 and processed accordingly. For example, if the movement sensor detects that the room is occupied, the property management system may receive an indication that the room is occupied and may notify the worker module and/or the worker devices 106 that the hotel room is not available for servicing. In other examples, in-room sensors may include beacons, e.g., Bluetooth beacons, or NFC devices which are discretely positioned in a hotel room. A beacon may broadcast its identifier to nearby mobile devices, e.g., guest devices 104 or worker devices 106, and enable the mobile devices to perform actions when in close proximity to a beacon. For example, a beacon may be used to determine a physical location of a mobile device or trigger a location-based action on a mobile device. The determined physical location of the mobile device may be provided to the property management system 112 over the network 102. For example, if the property management system 112 receives information that the guest mobile device is located in the guest hotel room, the property management system 112 may determine a likelihood that the guest is also located in the hotel room and notify the worker module and/or the worker devices 106 that the hotel room is not available for servicing. The in-room sensors may also include infrared sensors, sound sensors, and door opening sensors.

One or more sensors 110 may be property sensors that are located throughout the hotel. For example, property sensors may include beacons, e.g., Bluetooth beacons, or NFC devices which are discretely positioned in various locations throughout the hotel. The property sensors may be used to determine a physical location and path taken by a mobile device, enabling tracking of mobile devices. For example, a sequence of beacons may be used to track the movement of a guest mobile device through a hotel. The sequence of beacons may provide a sequence of physical locations of the mobile device to the property management system 112 over the network 102. The property management system 112 may use the sequence of physical locations to determine one or more possible directions that the guest mobile device, and in turn the hotel guest, is going and to subsequently notify the worker module. For example, the property management system 112 may receive a sequence of physical locations of a guest mobile device measured by the in-room and property sensors that indicate that the guest has left their room, taken the elevator to the lobby and exited the hotel. Depending on other factors, such as time of day, or other recently tracked movements, the property management system 112 may determine that the hotel guest has left the hotel for the day and will not return in the immediate future. The property management system may therefore notify the worker module that the room is available for servicing.

In some implementations, the sensors 110 may include guest mobile devices 104. For example, guest mobile devices 104 may act as beacons that emit signals. The hotel may include one or more beacon detectors that are configured to detect beacon signals that the phones emit.

One or more sensors 110 may be an external temperature sensor that is located outside the hotel. The external temperature sensor may be used to determine an external temperature value, which may be provided to a thermostat in-room device 108 over the network 102. The external temperature value may be used to determine an energy-efficient default temperature setting for an unoccupied hotel room.

A property management system 112 communicates with the components of the connected hotel system 100 and includes one or more software applications that coordinate operational functions of the hotel. For example, the property management system 112 may automate hotel functions such as guest bookings, guest personal details, online reservations, point of sale, telephone, accounts receivable, sales and marketing, banquets, food and beverage costing, materials management, HR and payroll, maintenance management, quality management and other amenities. In addition, property management system 112 may include a central reservation system and revenue or yield management system, a front office, a back office, door-locking and keycard system, pay-TV system, energy management system, payment card authorization and channel management systems. In some implementations the property management system may be provided to the hotel by a third party provider.

The property management system 112 is configured to receive requests from guests of the hotel through a hotel application that may be stored on a mobile device 104 of the guest. For example, the property management system 112 may receive a request from a guest that their room be given “do not disturb” status, either automatically or by placing a do not disturb sign on the door. The property management system 112 may forward the request to the task management system 124 or directly to the worker devices 106.

The property management system 112 receives information from the sensors 110 relating to the physical location of hotel guests. For example, the property management system 112 may receive an indication from an in-room motion sensor that a guest is occupying the room. The property management system 112 may forward this indication to the worker module. In some implementations, the property management system 112 may receive an indication from a Bluetooth beacon that a guest mobile device 104 is located in the guest room. The property management system 112 may use this information to determine a likelihood that the guest is occupying the room, e.g., that the guest has not left their mobile device in the room unattended. In other implementations, the property management system 112 may receive a sequence of locations of a guest mobile device from one or more property sensors 110. The property management system 112 may use this information to determine a likely path the guest is taking, e.g., whether the guest is likely to exit the hotel, is heading to the hotel restaurant, or is returning to their room. The determined likely path may be provided to the worker module. Based on the determined likely path, the task management system may reschedule a task and send it to a worker device.

A guest profile database 114 stores data relating to the interest and preferences of hotel guests. For example, a hotel guest may install a hotel application on one or more guest mobile devices, and use the hotel application to create and maintain a guest profile that is stored in the guest profile database 114. The guest profile may include information relating to the hotel guest, such as personal details, e.g., name, age, contact information; dietary requirements, e.g., vegetarian, gluten-free; room preferences, e.g., room with bathtub, air-conditioning, king size bed; arrival and departure dates, and interest in various hotel facilities. The guest profile may be sent to the hotel worker device to make sure the room is serviced accordingly.

An information database 118 stores data relating to the hotel and surrounding area. For example, the information database 118 may include information relating to available facilities in the hotel such as spa facilities or childcare services, restaurant details including opening times and menus, and room service options. The information database 118 may also include information relating to the surrounding area in which the hotel is located, such as near-by sights to see, local attractions and events, local restaurants or places to eat and local transport links. Hotel guests may access information stored in the information database 118 using a hotel application installed on a guest mobile device 104. In some implementations, information provided to a hotel guest using the information database 118 may be personalized according to the interests and preferences of the hotel guest, as specified in the guest profile database 114.

A maintenance management system 122 records and manages maintenance tasks that are to be performed in the hotel. The maintenance management system 122 may include an inventory of the property and may store information relating to scheduled replacements and services of devices located within the hotel. For example, the maintenance management system 122 may store information relating to each lighting device in the hotel, including when the lighting device was fitted, where the lighting device was fitted and when a service, e.g., the changing of a light bulb, is next due. The maintenance management system 122 may flag any upcoming services of electronic devices and provide service requests to the task scheduling management system 124 over the network 102. In some implementations the maintenance management system 122 may receive reports of damaged or failing devices, e.g., from the property management system 112 or from a worker device 106. The maintenance management system 122 may then send repair requests to the task management system 124 over the network 102. In other implementations the maintenance management system 122 may receive a report from the task management system 124 or from a worker device 106 that a device has failed and been repaired. The maintenance management system may then update the information relating to the device including the replacement schedule information accordingly.

A task management system 124 manages and schedules daily tasks that are to be performed. The task management system 124 may receive information daily from the property management system 112 over the network 102 relating to the hotel each day, such as hotel occupancy, events taking place at the hotel, or guests with special requirements. The task management system may use this information to create a shift schedule for each of the workers of the hotel. The shift schedules may be provided to the respective worker devices 106 over the network 102. In some implementations, the task management system 124 may receive updated information relating to the hotel, e.g., from the property management system, and dynamically edit the previous shift schedules of the hotel workers.

For example, the property management system may receive a request from a hotel guest that they wish to stay an additional night in the hotel. The property management system may inform the task management system 124 that the hotel guest will stay an additional night. The task management system 124 may therefore edit the shift schedule to indicate that the corresponding hotel room does not require a full service. In some implementations this may involve reducing the amount of time the assigned worker needs to complete their assigned work for the day. In other implementations the change to the shift schedule may include a revision of the shift schedule and the service task may be assigned a higher or lower priority within the worker's schedule, or may be assigned to another worker.

In another example, the task management system 124 may receive an automatic task creation request from an in-room device 108 as a result of a maintenance issue or failure. The task management system 124 may therefore edit one or more shift schedules to ensure that the maintenance issue is attended to. The edited shift schedules may be provided to the corresponding worker devices 106 over the network 102. In some implementations the task management system 124 may communicate with the property maintenance system 122 to indicate that a maintenance issue has been reported and attended to. For example, if the task management system 124 received a notification that a lighting device in a hotel room has failed, the task management system may edit the shift schedule of a maintenance worker to attend to the lighting device that day, and may report the lighting device failure and subsequent repair to the property maintenance system 122. The property maintenance system 122 may update their records to indicate that the lighting device has been repaired, and determine an expected future date in which the lighting device may need a next service or repair.

In a further example, the task management system 124 may be configured to receive an audio report from a worker device indicating a maintenance issue or failure. For example, a worker may use their worker device to inform the worker module that an in-room device has failed and needs repairing. The task management system 124 may include a speech recognition system that receives the audio report and generates a written representation of the received audio report. The written representation of the received audio report may be processed and a task creation request may be created. The task management system 124 may then edit one or more shift schedules to ensure that the task creation request is attended to. The edited shift schedules may be provided to the corresponding worker devices 106 over the network 102.

The connected hotel system 100 may be used to deliver new or enhanced experiences both to hotel guests and hotel workers. New or enhanced experiences for hotel guests are described below.

In some implementations, a guest of the hotel may use a mobile device 104 to update a hotel guest profile stored in the hotel guest profile database 114 prior to a planned stay at the hotel, e.g., two weeks prior to a planned stay. For example, a guest may have recently embarked upon a healthy lifestyle regime, and wish to update their hotel guest profile stored in the hotel guest profile database 114 to indicate an interest in using the hotel fitness facilities or to specify further dietary requirements such as low-fat or gluten-free. In another example, a guest may wish to update their hotel guest profile stored in the hotel guest profile database 114 to indicate that they would appreciate a hotel room with a double bed and a bath tub. As a further example, a guest may wish to update their hotel guest profile stored in the hotel guest profile database 114 to indicate an expected time of arrival, i.e., an expected check-in time. The updated hotel guest profile may be stored in the hotel guest profile database 114 and accessed by the property management system prior to the guest's planned stay. In some implementations the property management system may receive a notification that the hotel guest has updated their hotel guest profile.

In some implementations, the property management system 112 may access a hotel guest profile from the hotel guest profile database 114 prior to a guest's arrival and process the hotel guest profile in order to prepare for the guest's arrival. For example, the property management system 112 may process a hotel guest profile and determine that a guest has indicated an expected time of arrival and a preference for a hotel room with a double bed and a bath tub. Based on this information, the property management system 112 may prepare for the guest's arrival. For example, the property management system 112 may determine a list of rooms that will be available for use at the hotel guest's expected arrival time and that match some or all of the guest's indicated preferences. In some implementations the property management system 112 may use a hotel application installed on a guest device to provide the guest with a list of available rooms that best match their preferences for selection and reservation, prompted based on the guest's proximity to arrival.

In some implementations, the hotel guest may wish to prepare for their arrival at the hotel using a hotel application installed on a guest device. For example, as the guest makes their way to the hotel they may want to have food ready for consumption upon arrival. The guest may access the information database 118 to view the hotel food menus and place an order for room service using their mobile device. The property management system 112 may receive the request for room service and initiate preparation of the order accordingly.

In some implementations, the property management system 112 may access a hotel guest profile stored in the guest profile database 114 in order to generate one or more personalized recommendations for the hotel guest. For example, the property management system 112 may access a hotel guest profile and determine that the hotel guest has indicated an interest in using the hotel fitness facilities and specified dietary requirements such as low-fat or gluten-free. Based on this information, the property management system 112 may generate one or more personalized recommendations for the hotel guest, such as an invitation for a treatment at the spa or a suggestion to try a new gluten-free snack at the coffee shop. The personalized recommendations for the hotel guest can be provided to the guest through the hotel application installed on the guest's mobile device 104. In some implementations the property management system 112 may be configured to determine a location of the hotel guest within the hotel property, and provide the hotel guest with a personalized recommendation on their mobile device 104 at an appropriate time, such as when the hotel guest is walking towards the hotel spa or coffee shop. The personalized recommendations for the hotel guest can then also be provided to the guest through other methods, such as a graphical display located at the entrance to the spa or coffee shop.

In some implementations, the property management system 112 may access a hotel guest profile stored in the guest profile database 114 in order to determine a preferred room temperature of the hotel guest. For example, prior to the hotel guest's arrival, the property management system may determine a preferred room temperature of the hotel guest and program the in-room thermostat 108 accordingly.

In some implementations, the in-room devices 108 may automatically determine a maintenance issue or failure and automatically report the issue or failure to the worker module. The worker module may provide the reported issue or failure to the task management system 124 and a maintenance ticket may be created. For example, a light bulb in a hotel guest room may go out and a maintenance ticket may be automatically created accordingly. In other examples, a hotel guest may use the hotel application installed on their mobile device to inform the property management system 112 of the failure. In either case, a notification may be provided to the hotel guest, e.g., through the hotel application installed on the guest mobile device 104, informing the hotel guest that a maintenance ticket has been created. The notification may be automatically provided to the hotel guest mobile device 104, or may be visible to the hotel guest upon logging in to the hotel application installed on the hotel guest mobile device 104. The notification may remain visible to the hotel guest until the issue has been resolved. In some implementations the hotel guest may be further provided with an automatic notification when the maintenance issue has been resolved, indicating that the maintenance issue has been closed.

In some implementations, a hotel guest may activate hotel services using the hotel application installed on their guest mobile device 104. For example, a hotel guest may be enjoying breakfast in the hotel restaurant and remember that he/she forgot to place a do not disturb sign on the door. The hotel guest can place a request to the property management system 112 using their mobile device 104 that the do not disturb status of their room is activated. The property management system 112 may provide the request to the worker module using the network 102, and the request may be provided to the task management system for scheduling. In addition, upon receiving the request, the property management system 112 may provide the request to the worker devices 106, thus informing the hotel workers that the hotel room is not available for servicing and should not be entered.

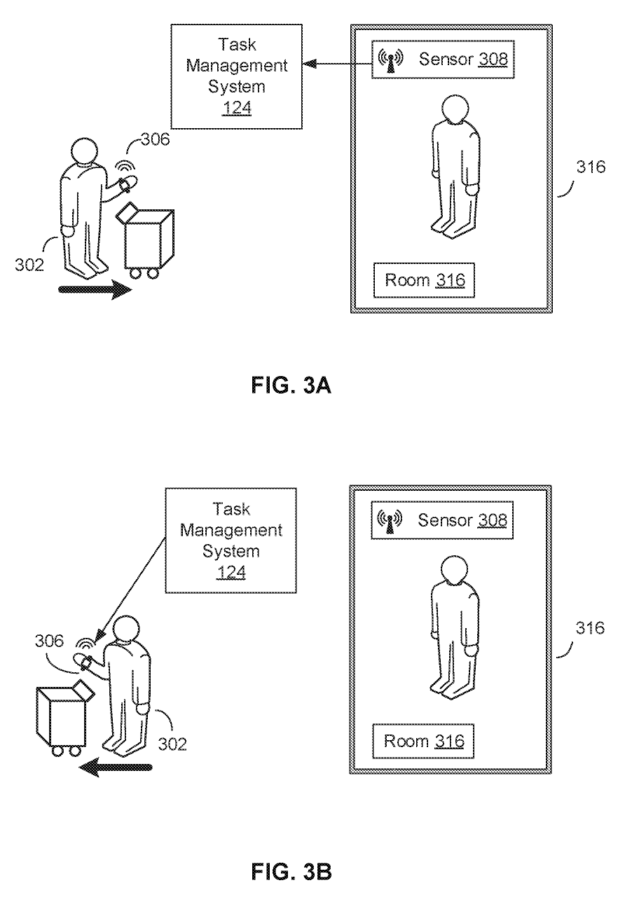

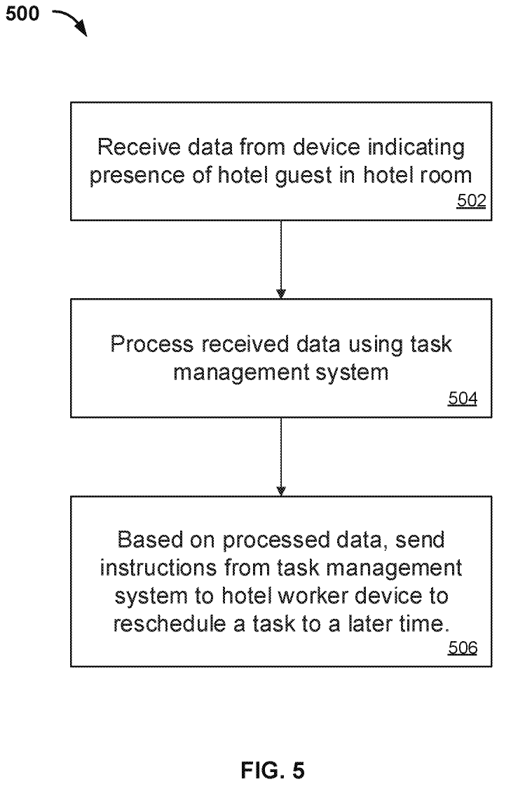

Continuing the example above, the hotel guest can also place a request to the property management system 112 using their mobile device 104 asking that the do not disturb status of their hotel room be deactivated and requesting that the room be serviced. The property management system 112 may provide the request to the worker module using the network 102, and the request may be provided to the task management system for scheduling. Dynamically altering a task schedule for connected hotel workers is described in more detail below with reference to FIGS. 3 and 5. When the room service has been completed, a notification may be provided to the hotel guest indicating that the room service is complete.

In some implementations, sensors 110, e.g., in-room sensors or property sensors, may determine that a hotel guest has left the hotel room and initiate energy saving procedures accordingly. For example, upon determining that the hotel guest has left the hotel room, the in-room thermostat may automatically set the room temperature to a property default value. In other examples, upon determining that the hotel guest has left the hotel room, the in-room lighting device or in-room entertainment devices may automatically turn off.

The connected hotel system 100 may be used to deliver new or enhanced experiences to hotel workers, as described below.

In some implementations, a hotel employee, such as a housekeeper, may arrive at the hotel to begin her work shift. The housekeeper may first collect an available worker device 106 from a docking station at the hotel. The worker device may be a wearable smart device, and the housekeeper may securely fix the worker device 106 in a preferred accessory, such as a wrist strap or belt. In some implementations the housekeeper may be assigned a particular worker device 106 from the docking station and the worker device 106 may be programmed with the housekeeper's current schedule. In other implementations the housekeeper may use an identification mechanism, such as a NFC enabled employee badge, to initiate the worker device to download the housekeeper's current schedule.

In some implementations, the housekeeper's current schedule may be altered according to the needs of the property, hotel workers and hotel guests in real-time. The worker device 106 may directly receive schedule alterations or updates and notify the employee of the changed schedule. For example, a hotel guest may indicate that they would like to check in early, e.g., through a hotel application installed on their mobile device or directly at the hotel reception. The property management system 112 can receive the request and provide the request to the task management system 124. The task management system 124 may process the request and immediately alter the schedule of a housekeeper such that a hotel room may be prepared for the hotel guest as soon as possible. The housekeeper may be notified of the alteration in their schedule through their worker device 106. Once the housekeeper has prepared the hotel room for the hotel guest, they are able to directly notify the property management system that the hotel room is ready. In some implementations the property management system 112 may automatically inform the guest through the hotel application installed on the guest's mobile device that their room is ready. In other implementations the property management system 112 may inform the hotel reception that the room is ready, and a member of the ground floor staff may personally inform the hotel guest that their room is ready.

In some implementations, a housekeeper's current schedule may be altered based on location information of the hotel guests determined by the in-room and property sensors. For example, an in-room sensor may indicate that the hotel room is empty, and that the room is available for servicing. If there is a housekeeper working near the empty room with a relatively light schedule, the task management system may alter the housekeeper's schedule to include servicing the empty room. In another example, a sequence of property sensors, e.g., a sequence of sensors leading from the guest hotel room, down the elevator and to the lobby, may indicate that a hotel guest is leaving the hotel, or that a hotel guest is going for breakfast in the hotel restaurant. Upon receiving such information, the task management system 124 may alter the schedule of one or more housekeepers such that the hotel room is serviced immediately or very soon. In some implementations the property management system may use the detected locations to determine a likelihood that the hotel guest is vacating their room for a significant amount of time. For example, if the detected locations indicate that the hotel guest is going down in the elevator, the property management system may determine that it is likely that the hotel guest is vacating their room for a significant amount of time, e.g., they are leaving the hotel premises, heading towards the restaurant for a meal, or heading towards the hotel fitness facilities. As another example, if the detected locations indicate that the hotel guest is walking down the corridor towards an ice machine, the property management system may determine that it is unlikely that the hotel is vacating their room for a significant amount of time, and that rather they are simply collecting some ice before returning to their room.

In some implementations the property management system may use the detected locations to determine a likelihood that the hotel guest is returning to their room. For example, if the detected locations indicate that the hotel guest is arriving at the hotel after some time away from the hotel, the property management system may determine that it is likely that the hotel guest is returning to their room. As another example, if the detected locations indicate that the hotel guest has been dining in the restaurant for some time, and that the hotel guest is now waiting for an elevator, the property management system may determine that it is likely that the hotel guest is returning to their room.

In other implementations, the property management system may use other signals to determine whether the hotel guest is likely to return to their room. For example, if it is detected that the hotel guest is using a credit card to pay for a meal in the restaurant, or charging a spa treatment to their room number, the property management system may use the detected signals to determine a likelihood that the hotel guest will return to their room.

Based on the determined likelihood, the property management system may program one or more in-room devices to switch on, switch off, or change their current settings. For example, a hotel guest may specify a preferred room temperature upon or prior to arrival at the hotel. A Heating, Ventilation and Air Conditioning (HVAC) in-room device may subsequently be programmed to maintain the guest's preferred temperature. If the system determines a likelihood that the hotel guest is returning to their hotel room, it may send instructions to the HVAC in-room device. For example, the instructions may include a temperature value for the in-room thermostat. The connected hotel system 100 can use an algorithm, e.g., a machine learning algorithm, to determine an optimal time to set the in-room thermostat to a certain temperature value in order to increase the chances that the temperature is at the guest's preferred temperature when the hotel guest returns to his/her room, e.g., through the use of cooling or heating curve calculations.

However, if the property management system determines that it is highly likely that the hotel guest will vacate their room for a significant amount of time, the HVAC in-room device may be programmed to turn off, or to reduce or increase the temperature of the room. The HVAC in-room device may be programmed to turn off, or to reduce or increase the temperature of the room based on several factors. For example, if the location of the hotel guest is tracked by a sequence of sensors, and it is determined that the guest is not leaving the hotel but is present somewhere in the hotel facilities, the HVAC in-room device may be programmed to a reduced energy setting that will not drastically change the temperature in the hotel room, since it may be assumed that the hotel guest may return to the their room soon, e.g., within one hour. If however the location of the hotel guest is tracked by a sequence of sensors and it is determined that the guest is leaving the hotel by automobile, the HVAC in-room device may be programmed to shut down entirely. In this case, it may be assumed that the hotel guest will not return to their room soon, e.g., within one hour.

Based on the determined likelihood, the property management system may program one or more in-room devices to switch on, switch off, or change their current settings. If the property management system determines that it is likely that the hotel guest is returning to their room, the in-room lighting device may be programmed to turn on. In another example, upon paying for a spa treatment and leaving the hotel fitness facilities the in-room lighting device may be programmed to turn on.

In some implementations, a housekeeper's schedule may include servicing a particular hotel room. The guest of the hotel room may notify the property management system 112, either through the hotel application on their mobile device or directly at reception, that they do not want their room servicing, or that they would like a different type of service, such as a full service or simply to have the towels replaced. In such a situation, the property management system 112 may notify the housekeeper, either directly at their worker device, or indirectly at the task management system 124, that the needs of the hotel guest have changed. The housekeeper's schedule may be altered accordingly.

In some implementations, a task may be dynamically reassigned or rescheduled using the worker devices 106. For example, a housekeeper's schedule may include servicing a particular hotel room. Upon arriving at the hotel room, the housekeeper may notice a do not disturb sign on the hotel room door. The housekeeper may instantly notify the task management system 124 that the room is unavailable for servicing using their worker device 106. The task scheduling manager may reassign or reschedule the room servicing task accordingly, and provide a notification of a schedule update on the corresponding hotel worker device.

In some implementations, upon departure the hotel guest may use the hotel application installed on their guest mobile device 104 to indicate that they have checked out and that the room is empty and available for servicing. Upon receiving such information, the task management system 124 may alter the schedule of one or more housekeepers such that the hotel room is serviced immediately or very soon in order to make it ready and available for a new guest.

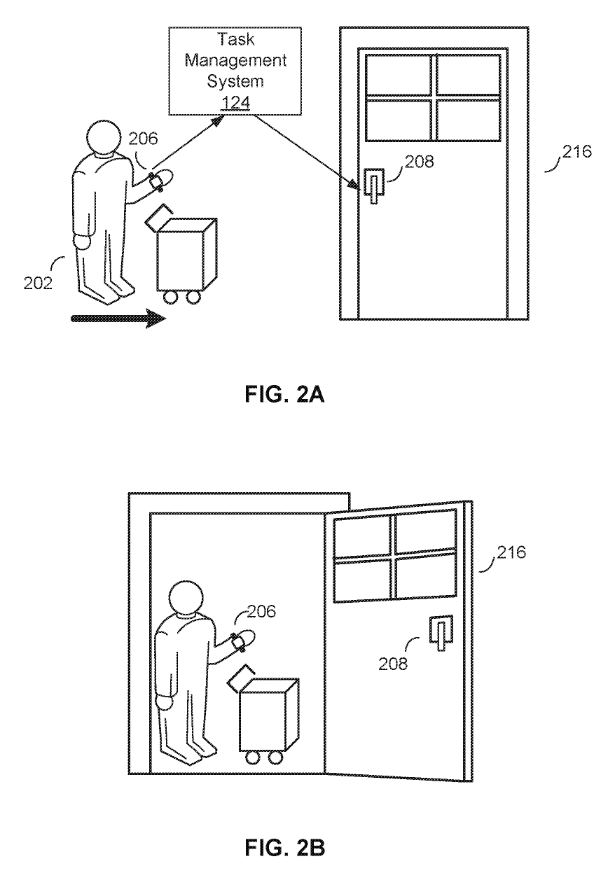

FIGS. 2A and 2B depict diagrams of an example process for dynamically controlling hotel room access. For example, as depicted in FIG. 2A, a housekeeper 202 with a hotel worker device 206 may be assigned to service a hotel room, e.g. room 216 at a scheduled time. As the housekeeper 202 approaches the room, the worker device 206 in use by the housekeeper 202 may send a request to a task management system, e.g., the task management system 124 of FIG. 1, asking for a dead bolt door lock 208 on the room door to be unlocked. The task management system may process the request in order to determine that the housekeeper 202 is permitted to enter the room at the scheduled time. As depicted in FIG. 2B, the system may determine that the housekeeper 202 is permitted to enter the room 216 and service the room at the scheduled time, and may instruct the automatic dead bolt door lock device 208 to unlock. In some implementations the dead bolt door lock device may automatically unlock.

FIGS. 3A and 3B depict diagrams of an example connected hotel worker process. For example, as depicted in FIG. 3A, a housekeeper 302 with a hotel worker device 306 may be assigned to service a hotel room, e.g. room 316 at a scheduled time. As the housekeeper 302 approaches the room, a task management system, e.g., the task management system 124 of FIG. 1, may receive in-room sensor data that indicates that the hotel room is currently occupied. As depicted in FIG. 3B, the task management system may therefore send an instruction to the hotel worker device 306 to inform the housekeeper 302 to cancel the current service assignment, so as not to disturb the hotel guest. In some implementations, this may involve reassigning or rescheduling the servicing of the hotel room.

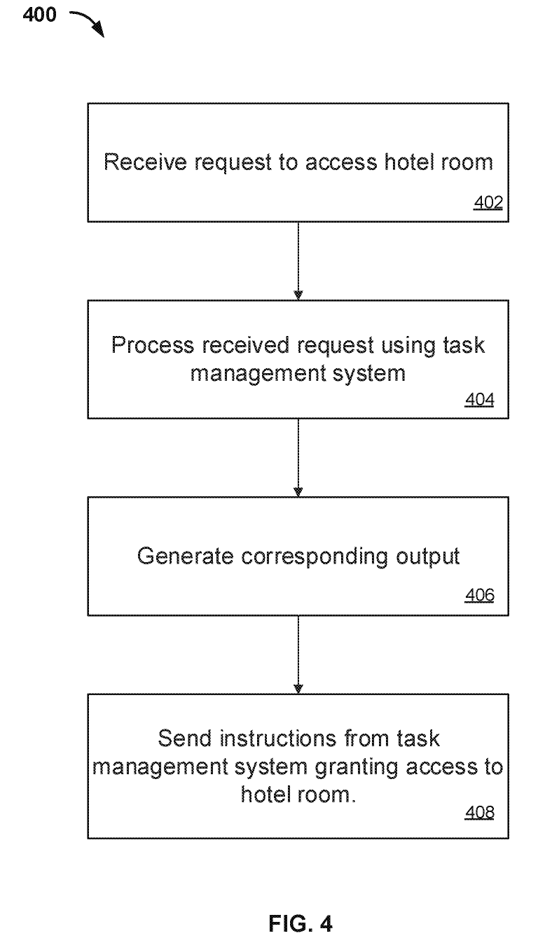

FIG. 4 depicts a flowchart of an example connected hotel worker process 400. The process 400 can be implemented, for example, by the connected hotel system 100 of FIG. 1 above.

The system receives a request to access a hotel room (step 402). For example, in order to increase a hotel guest's feeling of security, one or more hotel rooms may be installed with a dead bolt door lock. Instead of the dead bolt door lock being accessible to every hotel employee, or every hotel housekeeper in possession of a NFC access card programmed to gain entry to every room in the hotel, the dead bolt door lock may be dynamically unlocked for approved housekeepers at approved times. For example, a housekeeper may be assigned to service a hotel room with a dead bolt door lock at a scheduled time. At the scheduled time, a worker device in use by the housekeeper may send a request to the task management system that the dead bolt door lock be unlocked. The task management system may process the request in order to determine that the housekeeper is permitted to enter the room at the scheduled time (step 404).

The system receives an output from the task management system (step 406). For example, the system may confirm that the housekeeper is permitted to enter the room at the scheduled time. The task management system may provide as output an indication to the corresponding worker device that the housekeeper is permitted to enter the hotel room at that time.

Based on the received output, the system sends instructions granting access to the hotel room (step 408). For example, the system may determine that the housekeeper is permitted to enter the room and service the room at the scheduled time, and may instruct the automatic dead bolt door lock device to unlock. In some implementations the dead bolt door lock device may automatically unlock. In other implementations the housekeeper may require an additional key to unlock the door.

FIG. 5 depicts a flowchart of an example connected hotel worker process 500. The process 500 can be implemented, for example, by the connected hotel system 100 of FIG. 1 above.

The system receives data from a device (step 502). In some implementations, as described above with reference to FIG. 1, the device may include one or more in-room sensors. For example, the one or more in-room sensors may include one or more motion sensors, audio sensors or infrared sensors that are able to provide data indicating the presence of a hotel guest in a hotel room. In other implementations, the one or more in-room sensors may include sensors that are able to provide data indicating the failure of an in-room device. In some implementations, the in-room sensors may be integrated with the in-room devices. For example, a hotel room may be fitted with a motion sensor that generates data indicating the presence of a hotel guest and provides the data to a connected hotel system. In another example, the system may receive data from an in-room sensor indicating that a lighting device within the room has failed.

The system provides the data to a task management system, where it is processed (step 504). As described above with reference to FIG. 1, the task management system manages and schedules daily tasks that are to be performed, for example by dynamically creating a shift schedule for each of the workers of the hotel.

Based on the in-room sensor data, the system schedules hotel worker tasks (step 506). For example, the task management system may receive in-room sensor data that indicates a hotel room is currently occupied by a hotel guest. The task management system may therefore schedule the servicing of the hotel room for a later time, so as not to disturb the hotel guest. In some implementations, this may involve reassigning or rescheduling the servicing of the hotel room.

In another example, the task management system may receive in-room sensor data that indicates that a thermostat device in the hotel room has failed, or, in some implementations, that the thermostat device is about to fail. The task management system may therefore issue a maintenance request and schedule the servicing of the thermostat device as soon as possible, ideally prior to the device failing. In some implementations this may involve reassigning or rescheduling the servicing of the thermostat device.

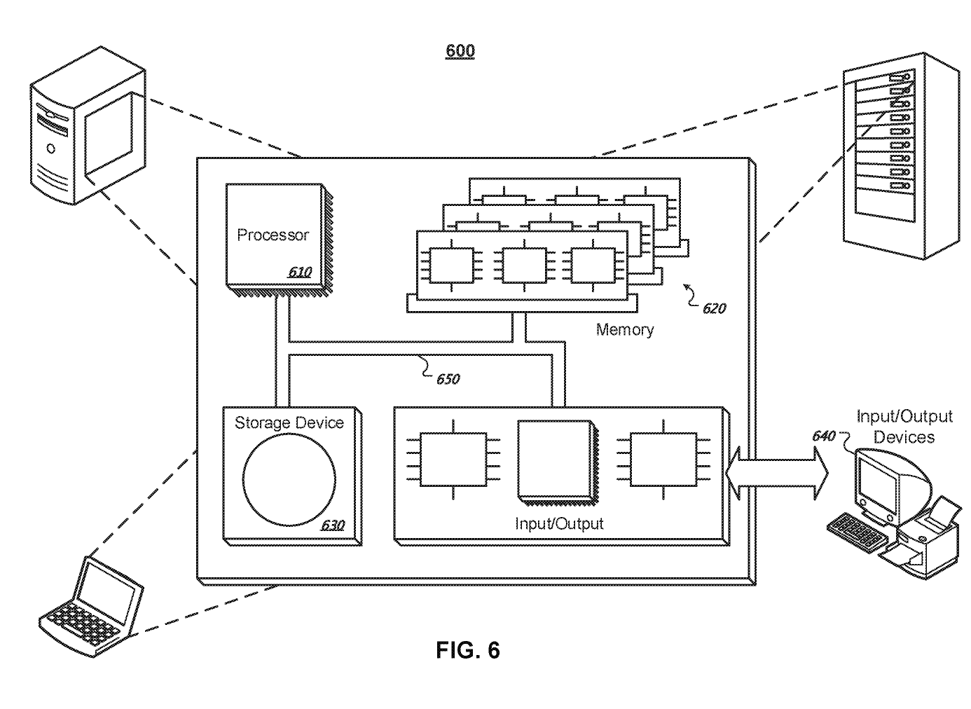

FIG. 6 illustrates a schematic diagram of an exemplary generic computer system. The system 600 can be used for the operations described in association with the processes 400 and 500 according to some implementations.

The system 600 includes a processor 610, a memory 620, a storage device 630, and an input/output device 640. Each of the components 610, 620, 630, and 620 are interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 may be a floppy disk device, a hard disk device, an optical disk device, or a tape device.

The input/output device 640 provides input/output operations for the system 600. In one implementation, the input/output device 640 includes a keyboard and/or pointing device. In another implementation, the input/output device 640 includes a display unit for displaying graphical user interfaces.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

For instances in which the systems and/or methods discussed here may collect personal information about users, or may make use of personal information, the users may be provided with an opportunity to control whether programs or features collect personal information, e.g., information about a user's social network, social actions or activities, profession, preferences, or current location, or to control whether and/or how the system and/or methods can perform operations more relevant to the user. In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained, such as to a city, ZIP code, or state level, so that a particular location of a user cannot be determined. Thus, the user may have control over how information is collected about him or her and used.

Embodiments and all of the functional operations described in this specification may be implemented in digital electronic circuitry, or in computer software, firmware, or hardware, including the structures disclosed in this specification and their structural equivalents, or in combinations of one or more of them. Embodiments may be implemented as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a stand alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both.

The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, embodiments may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments may be implemented in a computing system that includes a back end component, e.g., as a data server, or that includes a middleware component, e.g., an application server, or that includes a front end component, e.g., a client computer having a graphical user interface or a Web browser through which a user may interact with an implementation, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Thus, particular embodiments have been described. Other embodiments are within the scope of the following claims. For example, the actions recited in the claims may be performed in a different order and still achieve desirable results.

What is claimed is:

1. A method comprising:
receiving, from a device, a request to access a hotel room;
processing the received request using a task management system;
generating a corresponding output; and
based on the generated output, sending instructions from the task management system granting access to the hotel room.

2. The method of claim 1, wherein the device is a hotel worker device.

3. The method of claim 1, wherein the device is a guest device.

4. The method of claim 1, wherein processing the received request using a task management system comprises determining that the device is authorized to enter the room at the time that the request was received.

5. A method comprising:
receiving data from a device indicating the presence of a hotel guest in a hotel room;
processing the received data using a task management system; and
based on the processed data, sending instructions from the task management system to a hotel worker device to reschedule a task to a later time.

6. The method of claim 5, wherein the device is an in-room sensor.

7. The method of claim 5, wherein the device is a hotel worker device.

8. The method of claim 5, wherein the device is a guest device.

9. The method of claim 5, wherein the operations further comprise sending instructions from the task management system reassigning the task to a new hotel worker.

10. A computer-readable storage device storing software comprising instructions executable by one or more computers which, upon such execution, cause the one or more computers to perform operations comprising:
receiving, from a device, a request to access a hotel room;
processing the received request using a task management system;
generating a corresponding output; and
based on the generated output, sending instructions from the task management system granting access to the hotel room.

11. The device of claim 10, wherein the device is a hotel worker device.

12. The device of claim 10, wherein the device is a guest device.

13. A computer-readable storage device storing software comprising instructions executable by one or more computers which, upon such execution, cause the one or more computers to perform operations comprising:
receiving data from a device indicating the presence of a hotel guest in a hotel room;
processing the received data using a task management system; and
based on the processed data, sending instructions from the task management system to a hotel worker device to reschedule a task to a later time.

14. The device of claim 13, wherein the device is an in-room sensor.

15. The device of claim 14, wherein the in-room sensor is a motion sensor.

16. The device of claim 13, wherein the device is a hotel worker device.

17. The device of claim 13, wherein the device is a guest device.

18. The device of claim 13, wherein the operations further comprise sending instructions from the task management system reassigning the task to a new hotel worker.

19. A system comprising:
one or more computers and one or more storage devices storing instructions that are operable, when executed by the one or more computers, to cause the one or more computers to perform operations comprising:
receiving, from a device, a request to access a hotel room;
processing the received request using a task management system;
generating a corresponding output; and
based on the generated output, sending instructions from the task management system granting access to the hotel room.

20. A system comprising:
one or more computers and one or more storage devices storing instructions that are operable, when executed by the one or more computers, to cause the one or more computers to perform operations comprising:
receiving data from a device indicating the presence of a hotel guest in a hotel room;
processing the received data using a task management system; and
based on the processed data, sending instructions from the task management system to a hotel worker device to reschedule a task to a later time.
